(19) United States
(12) Patent Application Publication
(10) Pub. No.: US 2008/0028452 A1
(43) Pub. Date: Jan. 31, 2008

(54) Access control for secure portable storage device

(75) Inventors: Hondar Lee, Jhonghe City (TW); Tim Hsieh, Guanyin Township (TW); Patty Kuo, Taipei City (TW)

Correspondence Address: BIRCH STEWART KOLASCH & BIRCH, PO BOX 747, FALLS CHURCH, VA, 22040-0747, US

(73) Assignee: ATP ELECTRONICS TAIWAN, INC.

(21) Appl. No.: 11/637,110

(22) Filed: Dec. 12, 2006

(30) Foreign Application Priority Data
Jul. 26, 2006 (TW) 095127225

(51) Int. Cl. G06F 15/16; H04L 9/32

(52) U.S. Cl. 726/9

(57) ABSTRACT

The invention provides an access control for a secure portable storage device. The control method is applied to a host for accessing from the secure portable storage device. The control method includes the following steps. First, the host transmits a first key into a first temporary space in the file system of the secure portable storage device. Next, the secure portable storage device verifies if the first key is valid. If the first key is valid, an encrypted content key is duplicated into a second temporary space. Then, the encrypted content key is uploaded to the host. Afterward, the encrypted content key is decrypted into a content key. Lastly, an encrypted content data stored in the secure portable storage device is decrypted into a content data by use of the content key.

### BACKGROUND OF THE INVENTION

1. Field of the Invention

The present invention relates to an access control for a secure portable storage device, and more particularly, to an access control method for cross-verifying a key by a host and the secure portable storage device through a file system.

2. Description of the Prior Art

Conventional handheld computing devices are becoming increasingly popular. They have evolved from initially being applied as a portable notebook and a record keeper to having an expanded set of versatile functions in the present days. The storage capacity of common conventional handheld computing devices has a limit; thus, their memory is increased by plugging in small flash memory cards, such as memory cards (including multimedia cards and memory stick cards), to meet users' needs on storing bulk data, such as audio and video files.

As small flash memory cards with different specifications are sequentially launched in the market, end users already commonly utilize the small flash memory cards to store bulk data. Because there are confidential data or copyrighted data among the stored data, the end users or the data providers therefore hope to limit the access right of the stored data to a single user or a specific group of users. The current secure portable storage devices, or the so-called ‘secure media’, resolve the problem by sending a verification request to a user. That is, the content data in a file system is encrypted before the verification process is approved. A secure portable storage device and a host are required to cross-verify a key to obtain a valid content key. Next, the encrypted data is decrypted by use of the content key. Finally, the content data is transmitted out by the host.

In the current process for cross-verification of keys, a key is transmitted from a host to a secure portable storage device through a protocol unit. For example, the U.S. Pat. No. 6,892,306 discloses a process and an apparatus for encrypting a digital content, wherein the key is transmitted through the protocol unit. Moreover, the decryption of the key can be performed by the arithmetic unit of the secure portable storage device. However, the transmission of the data through the protocol unit (e.g., the application protocol data unit) must be performed through trivial protocol instructions to transmit the data slowly in a stepwise fashion. Based on the same reason, when the hardware of the secure portable storage device is upgraded, the host is required to also install a driver corresponding to the upgraded version so that data can be transmitted normally between the two. Furthermore, the decryption of the key is performed in the secure portable storage device, causing the encrypted data to be easily decrypted.

Accordingly, the invention is provided by the inventor to resolve the problems arose in prior art. The invention not only makes an improvement in the access control according to prior art, but also enhances the copy control mechanism of copyrighted data by cross-verifying a key through a file system at the same time.

### SUMMARY OF THE INVENTION

Accordingly, a scope of the invention is to provide a secure portable storage device which cross-verifies a key with a host through a file system, wherein the decryption of the encrypted data key is performed by the host.

Another scope of the invention is to provide an access control method for a secure portable storage device. The access control method is applicable to accessing an encrypted content data from a secure portable storage device by a host, wherein the host and the secure portable storage medium cross-verifies a key through a file system.

A preferred embodiment of the invention is a secure portable storage device, which includes a file system, a controlling/processing module, and a memory. The secure portable storage device can be detachably connected to a host, which includes a first decrypting module, a second decrypting module, and a pre-stored first key. The file system is coupled to the host and configured to store the encrypted content data. The file system also has a first temporary space and a second temporary space. The controlling/processing module is coupled to the file system. The memory is coupled to the controlling/processing module, and the memory stores therein an encrypted content key.

A control method according to the preferred embodiment of the invention is applicable to accessing from the secure portable storage device by the host. The control method includes the following steps. First, the first key is transmitted to the first temporary space. Next, the first key is verified to see if it is valid, and if the first key is verified to be valid, the encrypted content key stored in the memory is duplicated into the second temporary space. Then, the encrypted content key stored in the second temporary space is uploaded to the host by itself. Next, the encrypted content key is decrypted into a content key by use of the first key. Finally, the encrypted content data is decrypted into content data by use of the content key.

According to the invention, in the steps of the control method described above, the memory of the secure portable storage device also stores a second key, which is compared with the first key to verify the first key.

According to the invention, in the steps of the control method described above, the host includes a pre-stored third key, which is used in combination with the first key to decrypt the encrypted content key.

According to the invention, in the control method described above, the file system can comply with a FAT12 file system specification, a FAT 16 file system specification, a FAT 32 file system specification, or a NTFS file system specification.

The advantage and spirit of the invention may be understood by the following recitations together with the appended drawings.

### BRIEF DESCRIPTION OF THE APPENDED DRAWINGS

FIG. 1 is a system context diagram showing a host accessing from a secure portable storage device according to a preferred embodiment of the invention.

FIG. 2 is a flowchart of an access control method according to the preferred embodiment of invention.

### DETAILED DESCRIPTION OF THE INVENTION

The present invention provides an access control for a secure portable storage device. The access control is applicable to a host for accessing from the secure portable storage device. In particular, the host and the secure portable storage device cross-verify a key through a file system. The preferred embodiment according to the invention discloses the followings.

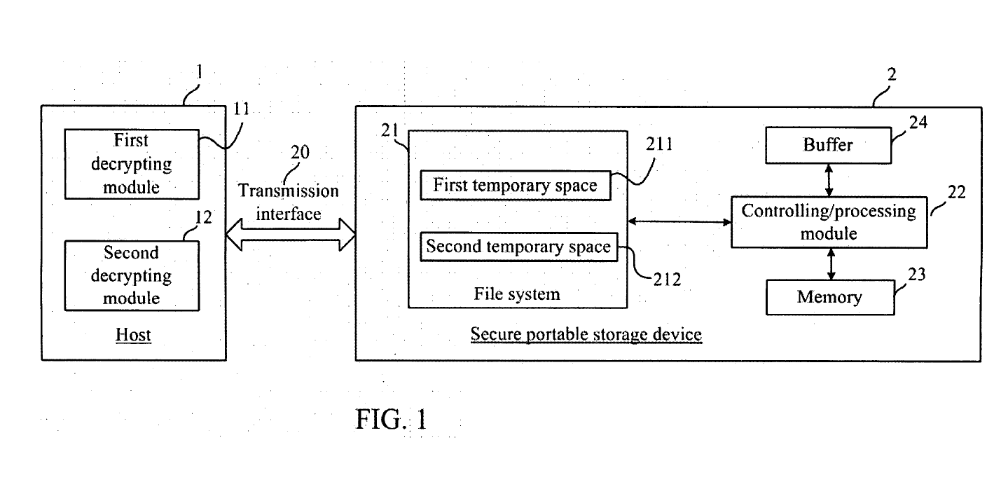

First, referring to FIG. 1, FIG. 1 is a system context diagram showing a host 1 accessing from a secure portable storage device 2 according to a preferred embodiment of the invention. The host 1 includes a first decrypting module 11 and a second decrypting module 12. The secure portable storage device 2 includes a file system 21, a controlling/processing module 22, a memory 23, and a buffer 24.

The host 1 described above can be an electronic device with an arithmetic function, such as a computer, a handheld communication device, a personal digital assistant, or a digital video disc playing device. The secure portable storage device 2 described above is used for storing encrypted content data, and the secure portable storage device 2 is usually called a memory card. The specification of the memory card described previously can be one selected from the specifications of a CompactFlash Card, a SmartMedia Card, a MultiMedia Card, a Memory Stick Card, an SD Memory Card, or an XD-Picture Card. The secure portable storage device 2 includes a transmission interface 20. As shown in FIG. 1, the secure portable storage device 2 can be detachably connected to the host 1 through the transmission interface 20.

In the secure portable storage device 2 in FIG. 1, the file system 21, coupled to the host 1, is configured to store encrypted content data. The file system 21 includes a first temporary space 211 and a second temporary space 212. In this case, each of the first temporary space 211 and the second temporary space 212 is a respective file. The file system 21 can also be a system context complying with a FAT 12 file system specification, a FAT 16 file system specification, a FAT 32 file system specification, or a NTFS file system specification, in accordance with applications in different environments. The controlling/processing module 22, coupled to the file system 21 and the memory 23, respectively, is a micro-controller, which is responsible for the controlling and the arithmetic functions of the secure portable storage device 2.

In the preferred embodiment of the invention, the host 1 pre-stores a first key, and the memory 23 of the secure portable storage device 2 pre-stores an encrypted content key. When the host 1 starts to access the secure portable storage device 2, the host transmits the first key to the first temporary space 211 of the secure portable storage device 2. The controlling/processing module 22 accesses the first key, and verifies if the first key is valid. If the first key is valid, the encrypted content key is duplicated into the second temporary space 212. The host 1 also uploads the encrypted content key stored in the second temporary space 212 by itself. The first decrypting module 11 of the host 1 is an arithmetic unit. The first decrypting module 11 uses the first key to decrypt the encrypted content key into a content key. The second decrypting module 12 uses the content key to decrypt the encrypted content data into content data. The host 1 can then transmit the content data out normally.

The decrypting algorithm built in the first decrypting module 11 and the second decrypting module 12 are prior art, and the decrypting algorithm is written in accordance with practical needs. Therefore, the decrypting algorithm is not described in details here.

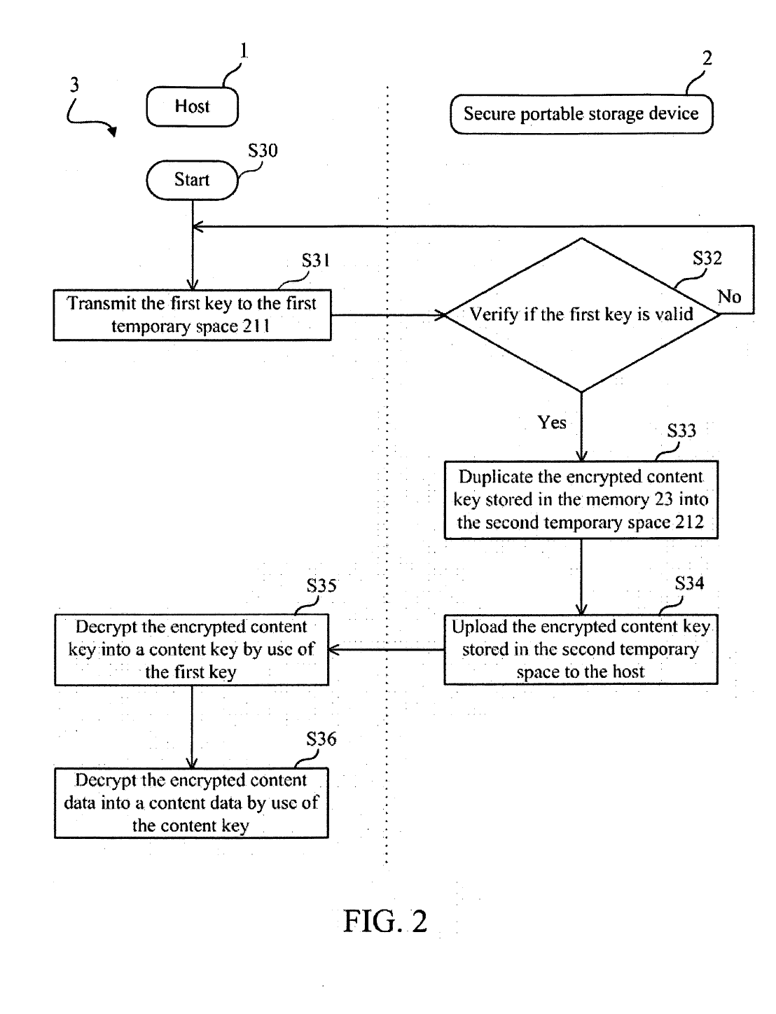

Then, referring to FIG. 2, FIG. 2 is a flowchart of the access control method 3 according to the preferred embodiment of invention. Please refer to FIG. 1 and relevant figure for the related system context. In FIG. 2, the step S30 of the control method 3 is first performed when the host 1 requests to access the encrypted content data of the secure portable storage device 2.

Next, the host 1 transmits the first key to the first temporary space 211 of the secure portable storage device 2 (step S31).

Then, the secure portable storage device 2 performs the verifying of the first key, in response to the change in the first temporary space 211. The controlling/processing module 22 downloads the first key stored in the first temporary space 211 to the buffer 24 to verify if the first key is valid (Step S32).

If the first key is verified to be valid, the step S33 is performed. The controlling/processing module 22 duplicates the encrypted content key pre-stored in the memory 23 into the second temporary space 212 (step S33).

Next, the controlling/processing module 22 uploads the encrypted content key stored in the second temporary space 212 to the host 1 (Step S34).

Next, the first decrypting module 11 uses the first key to decrypt the encrypted content key into the content key (Step S35).

Finally, the second decrypting module 12 uses the content key to decrypt the encrypted content data into content data (Step S36).

The inventor states that after the control method 3 is started and before the host 1 transmits the first key to the first temporary space 211, the controlling/processing module 22 can first clear the content of the first temporary space 211 and the second temporary space 212. At the same time, as described in step S34, after the second key stored in the second temporary space 212 is uploaded to the host 1, the controlling/processing module 22 can also clear the second temporary space 212. In this way, the security of the first key and the encrypted content key can be more complete.

In one embodiment of the invention, the memory 23 pre-stores a second key. In step S32, the verification of the first key is performed by comparing the first key with the second key.

In one preferred embodiment of the invention, the host 1 also includes a pre-stored third key. In the step S35, the decryption of the encrypted content key can be performed by use of the first key and the third key at the same time, or by using either the first key or the third key. The decryption method described here uses a combination of the first key and the third key to perform a decryption.

Accordingly, by the specifications of the invention above, one can clearly see that the access control of the secure portable storage device disclosed in the invention performs, based on the file system, the verification process of the key between the host and the secure portable storage device. At the same time, the performing of the decrypting algorithm of the encrypted content key is totally responsible by the host. In prior art, the verification process is performed through the protocol, and the decrypting algorithm of the encrypted content data is performed in the secure portable storage device. Obviously, the technology according to the invention differs from that according to prior art, and according to the access control method of the secure portable storage device of the invention, the host no longer needs to install a driver corresponding to the upgraded version to cope with the secure portable storage device when its hardware is upgraded. Moreover, the decrypting algorithm of the encrypted content key is totally the responsibility of the host, thus guaranteeing the copy control mechanism of copyrighted data.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A secure portable storage device capable of being detachably connected to a host comprising a first decrypting module, a second decrypting module, and a pre-stored first key, said secure portable storage device comprising:
a file system, coupled to the host and configured to store an encrypted content data, having a first temporary space and a second temporary space;
a controlling/processing module being coupled to the file system; and
a memory, coupled to the controlling/processing module, storing therein an encrypted content key;
wherein when the host transmits the first key to the first temporary space of the secure portable storage device, the controlling/processing module accesses the thirst key and verifies if the first key is valid, and if the first key is verified to be valid, duplicates the encrypted content key into the second temporary space, and then the encrypted content key is stored in the second temporary space, the encrypted content is also uploaded to the host, the first decrypting module decrypts the encrypted content key into a content key by use of the first key, the second decrypting module decrypts the encrypted content data into content data by use of the content key.

2. The secure portable storage device of claim 1, wherein the memory also stores a second key, and the controlling/processing module compares the first key with the second key to verify if the first key is valid.

3. The secure portable storage device of claim 1, wherein the host also comprises a pre-stored third key, the first decrypting module decrypts the encrypted content key into the content key by use of the first key and the third key.

4. The secure portable storage device of claim 1, further comprising a buffer coupled to the controlling/processing module, wherein the controlling/processing module downloads the first key stored in the first temporary space to the buffer before verifying if the first key is valid.

5. The secure portable storage device of claim 1, wherein the controlling/processing module clears the first temporary space and the second temporary space before the host transmits the first key to the secure portable storage device.

6. The secure portable storage device of claim 5, wherein the controlling/processing module detects the change in the first temporary space, and executes the verifying of the first key in response to the change in the first temporary space.

7. The secure portable storage device of claim 1, wherein the file system complies with one selected from the group consisting of a FAT12 file system specification, a FAT16 file system specification, a FAT32 file system specification, and a NTFS file system specification.

8. The secure portable storage device of claim 1, wherein after the encrypted content key stored in the second temporary space is uploaded to the host, the host clears the second temporary space.

9. A control method for accessing from a secure portable storage device by a host comprising a pre-stored first key, the secure portable storage device, capable of being detachably connected to the host, comprising a memory therein storing an encrypted content key and a file system, the file system, coupled to the host and configured to store an encrypted content data, having a first temporary space and a second temporary space, said control method comprising the steps of:
transmitting the first key to the first temporary space;
verifying if the first key is valid, and if the first key is verified to be valid, duplicating the encrypted content key stored in the memory into the second temporary space;
uploading the encrypted content key stored in the second temporary space to the host;
decrypting the encrypted content key into a content key by use of the first key; and
decrypting the encrypted content data into a content data by use of the content key.

10. The control method of claim 9, wherein the memory also stores a second key, and the verifying of the first key is performed by comparing the first key with the second key.

11. The control method of claim 9, wherein the host also comprises a pre-stored third key, the decrypting of the encrypted content key into the content key is performed by use of the first key and the third key.

12. The control method of claim 9, wherein the first temporary space and the second temporary space are cleared before transmitting the first key to the first temporary space.

13. The control method of claim 12, wherein the verifying of the first key is performed in response to the change in the first temporary space.

14. The control method of claim 9, wherein the file system complies with one selected from the group consisting of a FAT12 file system specification, a FAT16 file system specification, a FAT32 file system specification, and a NTFS file system specification.

15. The control method of claim 9, wherein after the second key stored in the second temporary space is uploaded to the host, the second temporary space is cleared.
